(19) United States
(12) Patent Application Publication
(10) Pub. No.: US 2012/0109708 A1
(43) Pub. Date: May 3, 2012

(54) EVALUATING PATTERN-BASED CONSTRAINTS ON BUSINESS PROCESS MODELS

(75) Inventors: Jens Mueller, Karlsruhe (DE); Mario Graf, Achern (DE)

(73) Assignee: SAP AG, WALLDORF (DE)

(21) Appl. No.: 12/939,026

(22) Filed: Nov. 3, 2010

(51) Int. Cl. G06Q 10/00

(52) U.S. Cl. 705/7.27

(57) ABSTRACT

Methods and related systems for evaluating pattern-based constraints on business process models provide specifications for business process models, related structural patterns, and constraints on structural patterns so that instances of structural patterns can be identified in models and constraints on these instances can be evaluated. Model elements may include tasks that correspond to prescribed activities, events that correspond to states of the model, and gateways that control process flow between model elements. Identifying instances of structural patterns within models may include assigning classes or textual labels to model elements and then employing a search query or production rule to search over the model elements for instances of the structural patterns.

### TECHNICAL FIELD

The present disclosure relates to computing generally and more particularly to software related to business process models.

### DESCRIPTION OF RELATED ART

When modeling business processes with the Business Process Modeling Notation (BPMN), business users typically adhere to certain domain-specific constraints that refer to the structure and semantics of business process models. [1, 2, 3, 4, 5] For example, a constraint may state that a sequence of model elements that have a certain meaning (e.g., tasks with certain labels or links to web service operations) must not exist within business process models. Another constraint may state that all sequences of model elements with certain labels must be followed by a specific model element (e.g., an event). When constraints are violated, execution of the corresponding business processes (e.g., by humans or machines) may lead to undesired results or, in the worst case, critical situations.

In general, these constraints may be understood as restrictions on patterns of model elements in business process models, and requirements for modeling these constraints create significant challenges for related software modeling tools. In some cases, problems arise when constraints cannot be adequately captured by modeling tools or when the number and complexity of constraints makes it difficult for modeling tools to simultaneously satisfy the constraints. In addition, constraints may change over time so that existing process models have to be re-examined every time constraints are altered.

### SUMMARY

Certain embodiments provide specifications for business process models, structural patterns for describing arrangements of business process model elements and constraints on structural patterns so that instances of structural patterns can be identified in models and constraints on these instances can be evaluated.

One embodiment relates to a method of evaluating pattern-based constraints on business process models. The method includes receiving values for specifying a business process model that includes a first arrangement of model elements including one or more tasks, events or gateways, where the tasks correspond to prescribed activities, the events correspond to states of the model and the gateways control process flow between model elements. The method further includes receiving values for specifying one or more structural patterns for the model and receiving values for specifying a constraint on the model by restricting an arrangement in the model of one or more instances of the one or more structural patterns. The method then includes identifying one or more instances of the one or more structural patterns in the model and evaluating the constraint on the model for the one or more identified instances.

Specifying the business process model may include assigning classes (i.e., domain concepts or ontology classes) or textual labels to model elements. Identifying the one or more instances may include employing a search query or production rule to search over the model elements for instances of the structural patterns. Evaluating the constraint on the model may include using a process-flow description that characterizes the one or more identified instances within the model to simulate states of the model and using logical check values that characterize the constraint through logical operations to verify the constraint on the simulated states. Another embodiment relates to an apparatus for carrying out the above-described method, where the apparatus includes a computer for executing instructions related to the method. For example, the computer may include a processor with memory for executing at least some of the instructions. Additionally or alternatively the computer may include circuitry or other specialized hardware for executing at least some of the instructions. Another embodiment relates to a computer-readable medium that stores (e.g., tangibly embodies) a computer program for carrying out the above-described method with a computer. In these ways aspects of the present invention enables improved methods and related systems for evaluating pattern-based constraints on business process models.

### BRIEF DESCRIPTION OF THE DRAWINGS

FIG. 1 is a BPMN diagram that relates to a model, according to an example embodiment.

FIG. 2 is a flowchart showing a method of evaluating pattern-based constraints on business process models, according to an embodiment.

FIG. 3 shows a summary of example PPML modeling constructs including graphical symbols, names and summary descriptions.

FIG. 4 shows two example structural patterns in the PPML framework.

FIG. 5 shows a summary of example PCML modeling constructs including graphical symbols, names and summary descriptions.

FIG. 6 shows an example compound pattern-based constraint in the PCML framework.

FIG. 7 shows a method of identifying instances of structural patterns in business process models according to another embodiment.

FIG. 8 shows a semantic enrichment diagram for the embodiment of FIG. 7.

FIG. 9 shows a simple BPMN diagram without semantic enrichment.

FIG. 10 shows a simple BPMN diagram with semantic enrichment.

FIG. 11 shows an example representation of a structural pattern with a corresponding conjunctive query.

FIG. 12 shows an example display for identified structural patterns.

FIG. 13 shows a method of evaluating a constraint on identified instances of structural patterns in business process models according to another embodiment.

FIG. 14 shows an example LTL formula that corresponds to a pattern-based constraint.

FIG. 15 shows an example diagram that corresponds to a PROMELA program for a business process model.

FIG. 16 shows an example diagram that corresponds to a PROMELA program with a reduced number of process declarations for a business process model.

FIG. 17 shows an example graphical display of an evaluated constraint.

FIG. 18 shows an example graphical display of an evaluated constraint where a violation of the constraint is highlighted in the business process model.

FIG. 19 shows a method of identifying instances of structural patterns in business process models according to another embodiment.

FIG. 20 shows an example representation of a structural pattern with a corresponding production rule.

FIG. 21 shows a conventional general-purpose computer system.

### DETAILED DESCRIPTION OF EXAMPLE EMBODIMENTS

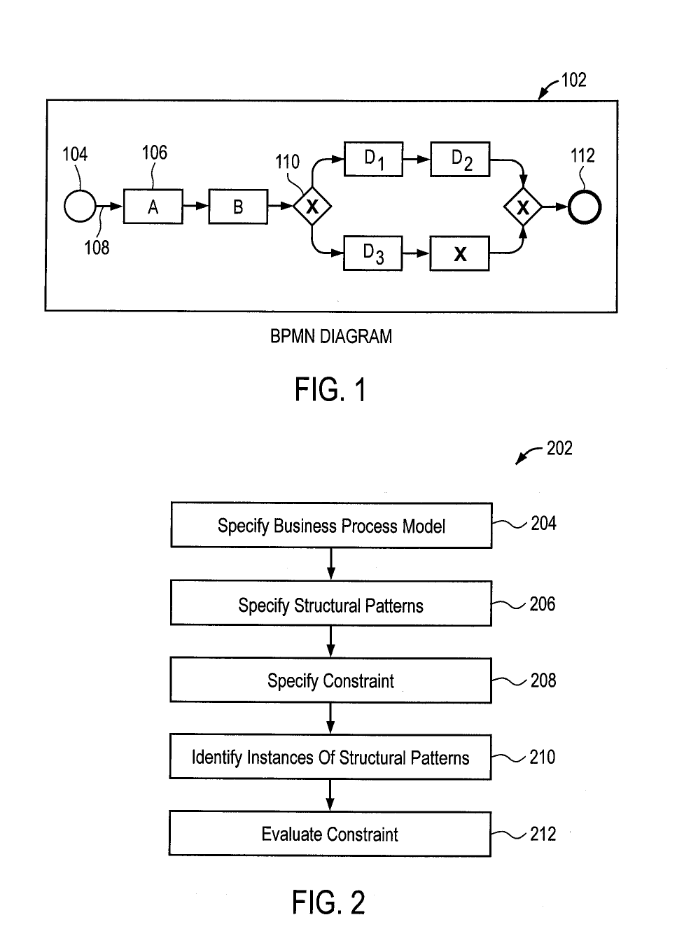

FIG. 1 shows a Business Process Modeling Notation (BPMN) diagram 102 that relates to example embodiments. The diagram 102 describes a model that includes events 104, 112, tasks 106, sequence connectors 108 and gateways 110. In this case, a start event 104 is connected to task A 106, which is followed by task B. A gateway then connects to two separate task sequences, task D₁ followed by task D₂, and task D₃ followed by task X. A final gateway leads to an end event 112 that indicates the termination of the sequence. As discussed below, events generally indicate properties or states of the underlying model or system, tasks indicate prescribed activities, gateways control flow along paths of the model and sequence connectors connect model elements. Internally, the diagram 102 is typically represented as a Meta Object Facility (MOF) model (e.g., as in SAP NETWEAVER BUSINESS PROCESS MANAGEMENT (BPM)). The MOF specification is the foundation of the Object Management Group (0MG) industry-standard environment where models can be exported from one application, imported into another, transported across a network, stored in a repository and then retrieved, rendered into different formats (e.g., including XML Metadata Interchange (XMI), OMG's format based on eXtensible Markup Language (XML) for model transmission and storage), transformed, and used to generate application code. [11]

FIG. 2 is a flowchart showing a method 202 of evaluating pattern-based constraints on business process models according to an embodiment. First, a business process model (BPM) is specified as an arrangement of model elements including one or more tasks, events or gateways 204. As in the above-described model 102, typically the tasks correspond to prescribed activities, the events correspond to states of the model and the gateways control process flow between model elements. Next, one or more structural patterns (SPs) are specified for the model, where each structural pattern includes a corresponding arrangement of one or more model elements (e.g., tasks, events or gateways) 206. Next a constraint on the model is specified by restricting an arrangement in the model of one or more instances of the one or more structural patterns 208. Next, with these specifications, the method 202 includes identifying one or more instances of the one or more structural patterns in the model 210 and evaluating the constraint on the model for the one or more identified instances 212.

For specifying the model 204, the structural patterns 206 and the constraint 208, this embodiment includes modeling compliance constraints that relate to the existence of certain sets of related model elements or to the temporal relationships between different sets of model elements. To model descriptions of such sets of model elements and to model compliance constraints that refer to these descriptions, this embodiment employs two corresponding modeling languages: the Process Pattern Modeling Language (PPML) and the Process Constraint Modeling Language (PCML).

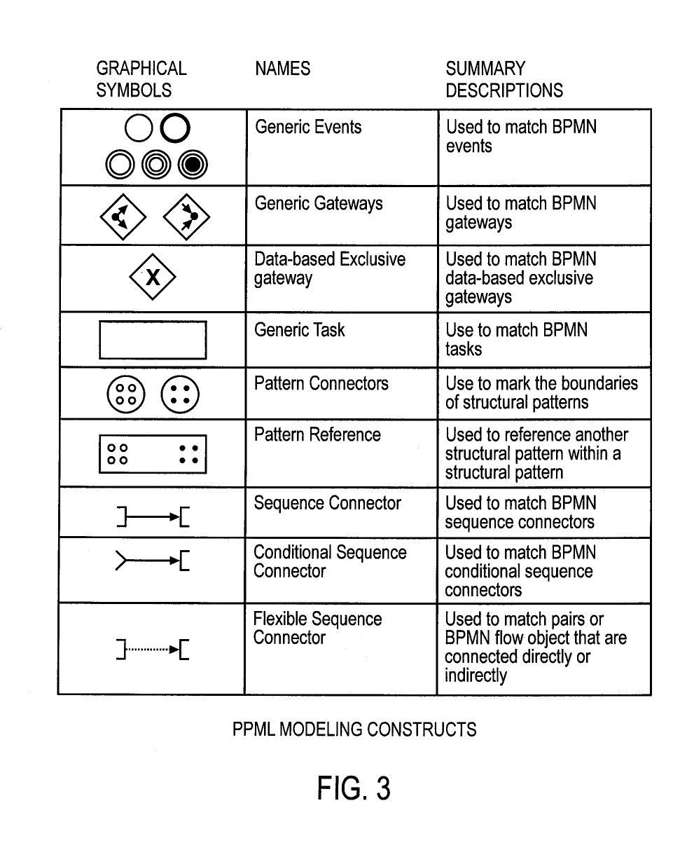

First, the BPM can be specified 204 and the SPs can be specified 206. FIG. 3 shows a summary of example PPML modeling constructs including graphical symbols, names and summary descriptions (e.g., relative to conventional BPMN elements). PPML is a modeling language for explicitly specifying descriptions of sets of model elements of interest (i.e., an SP). As illustrated in FIG. 3, the graphical notation of many PPML constructs is consistent with corresponding features of BPMN. However, additional constructs (e.g., pattern connectors and pattern references) are also employed thereby enhancing the applicability of corresponding methods. In this way, PPML provides generic and flexible modeling constructs that allow combining similar patterns within a single pattern model. Furthermore, PPML provides modeling constructs that allow connecting different pattern models thereby ensuring modularity.

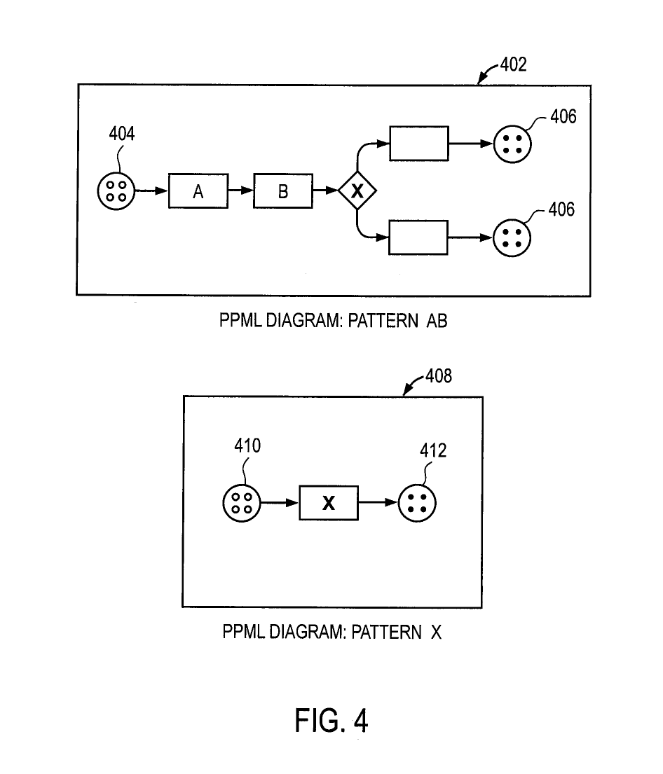

FIG. 4 shows two example structural patterns in the PPML framework. With reference to FIG. 3, Pattern AB 402 includes two labeled generic tasks, A and B, two unlabeled generic tasks, sequence connectors, a gateway, a starting pattern connector 404, and two ending pattern connectors 406. Pattern X 408 includes a labeled generic task X, a starting pattern connector 410, and an ending pattern connector 412. Dashed lines are used in FIG. 4 to show that the starting pattern connectors 404, 410 and ending pattern connectors 406, 412 are not themselves matched in the pattern-matching process as described below.

Several authors have proposed visual languages to query BPEL (Business Process Execution Language) processes [3] and BPMN diagrams [2, 5]; however, these approaches were generally directed to different operational settings with different goals. PPML, in some example embodiments, introduces novel modeling constructs that focus on generality (e.g., generic tasks, events, and gateways), flexibility (e.g., flexible sequence flow), and modularity (e.g., pattern connectors, pattern reference). Furthermore, PPML is not just a graphical notation but a modeling language based on a standard-compliant modeling infrastructure, which offers many advantages, such as metadata management and serialization.

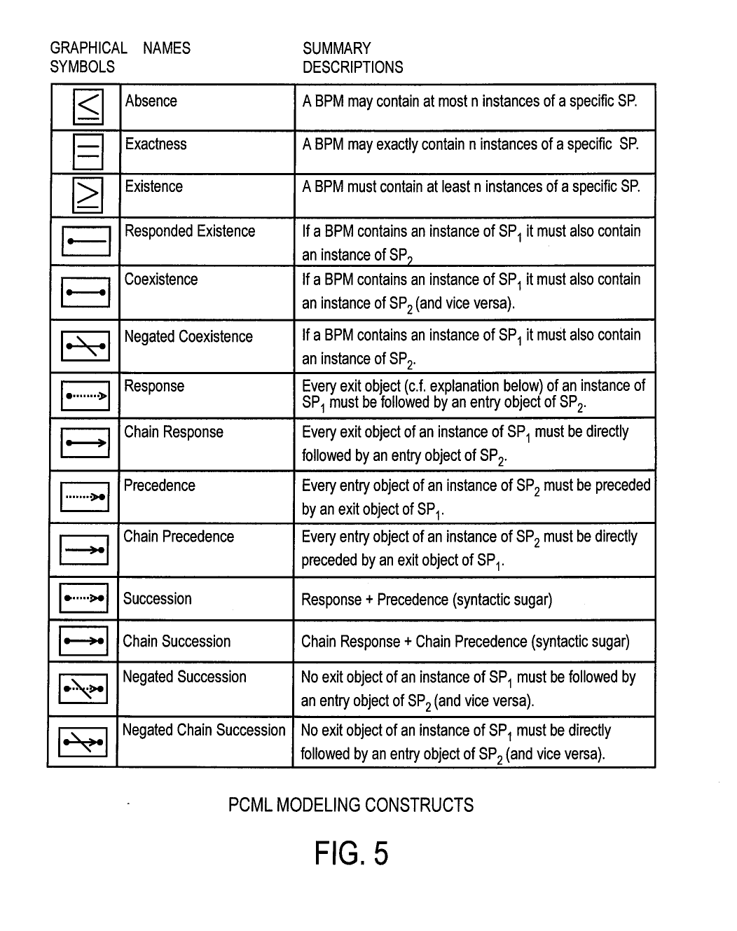

FIG. 5 shows a summary of example PCML modeling constructs including graphical symbols, names and summary descriptions. PCML is a modeling language for specifying statements related to the existence of a certain set of related model elements with a specific meaning or a temporal relationship between different sets of model elements. Note that the summary descriptions include the term “syntactic sugar” to indicate that certain PCML constructs can be understood as logical combinations of other PCML constructs (e.g., Succession as a logical combination of Response and Precedence).

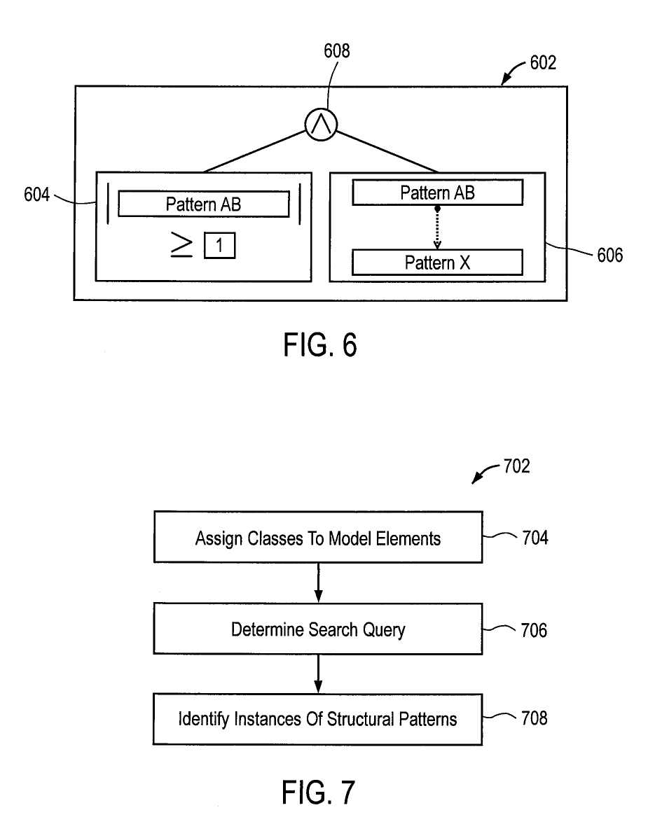

Next, the constraint can be specified 208 using the constructs of PCML (FIG. 5). FIG. 6 shows an example PCML diagram that shows a compound constraint 602. The compound constraint 602 includes a first constraint C 1 604, an existence condition that requires the presence of at least one instance of pattern AB 402, and a second constraint C2 606, a response condition that requires that every instance of pattern AB is followed by an instance of pattern X. A logical AND 608 indicates that both conditions are required for the compound constraint 602.

A more detailed embodiment for specifying the model 204 and identifying instances of the structural patterns 210 is shown in FIG. 7, where classes (i.e., domain concepts or ontology classes) are used in the search process. The method 702 includes assigning classes to the model elements as an aspect of specifying the model 204, where the classes correspond to different business concepts in a relational data structure of business classifications 704. Next, as an aspect of identifying instances of the structural patterns 210, a search query is determined for identifying a structural pattern as an arrangement of classified model elements 706, and instances of the structural pattern are identified by using (e.g., processing) the search query to search over elements of the business process model to match the structural pattern 708.

In BPMN, the meaning of model elements is expressed by labeling them using natural language (e.g., A, B, etc. in FIG. 1). Additional meaning can be expressed by assigning model elements to non-ambiguous domain concepts that can be described using ontology classes. Although this semantic tagging poses additional overhead for modelers, business process analysis benefits considerably from the enhanced capabilities that result from machine-readable semantics.

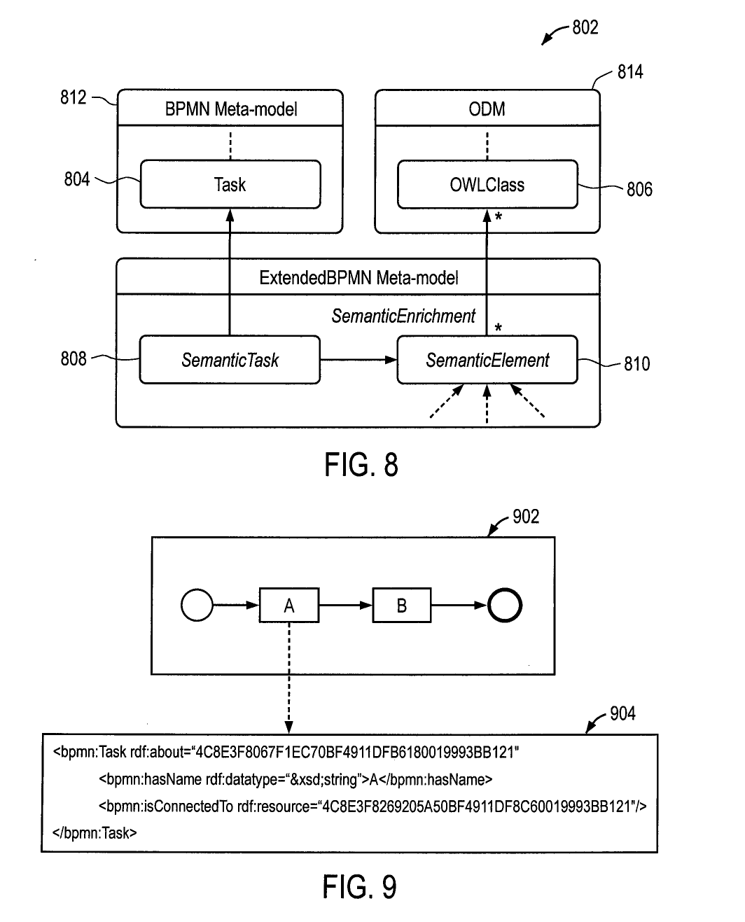

For assigning classes to the model elements 704, certain embodiments include a semantic enrichment of model elements based on Web Ontology Language (OWL) ontologies. [5] FIG. 8 shows an embodiment that relates the BPMN meta-model to the Ontology Definition Metamodel (ODM) that describes the structure of an OWL ontology on the MOF level, thereby enabling MOF-based modeling tools to work with OWL elements.

In FIG. 8, a Unified Modeling Language (UML) class diagram 802 shows the relationship between tasks 804 that are part of the BPMN meta-model and ontology classes 806 that are part of the ODM. Thus, a semantic task 808 is a subclass of a task 804 and a subtask of a semantic element 810, and each semantic element 810 is associated with zero or more classes 806. The relationship between semantic elements and classes is realized by an MOF association between the BPMN meta-model 812 and the ODM 814 so that embodiments desirably employ semantic tagging at the model level (e.g., the MOF specification). Existing approaches have realized semantic tagging on the ontology level so that business process diagrams are represented as ontologies instead of models [5].

To process a search query with a reasoner (as described below), a BPMN diagram or rather the corresponding MOF model is transformed into an OWL ontology, known as a business process ontology. This business process ontology imports another ontology, known as a BPMN ontology, that describes how BPMN diagrams can be represented on the ontology level. To perform the transformation, a recursive algorithm traverses each element of the MOF model and creates corresponding OWL individuals in the business process ontology. These OWL individuals are created as members of classes defined in the BPMN ontology, whereas the needed attributes of the MOF model elements (e.g., labels of tasks or source and target objects of sequence connectors) are reflected as data and object properties of the corresponding individuals. In addition, the created OWL individuals can also be declared as members of classes of domain ontologies if the corresponding BPMN model elements are semantically enriched. This is possible because OWL allows multiple class memberships.

Typically each MOF model element has its own unique identifier or MOF-ID (e.g., as in SAP NETWEAVER BPM). During the transformation these MOF-IDs are extracted and used as identifiers of the corresponding elements in the business process ontology. Therefore, it is very easy to perform a mapping between OWL individuals that are part of a pattern instance and their corresponding MOF model elements in the BPMN diagram after the termination of the pattern matching phase 708.

FIG. 9 shows a simple BPMN diagram 902 without semantically enriched model elements. Two model elements, task A and task B, are shown together with a portion of an OWL description 904 for task A. This OWL description 904 (in the RDF/XML format) results from transforming task A into a corresponding individual of an OWL ontology. Task A is transformed into an individual of type bpmn:Task, which is described within the BPMN ontology. This description 904 includes a datatype property (hasName: specifies the label of the task) and an object property (isConnectedTo: used to evaluate flexible sequence connectors).

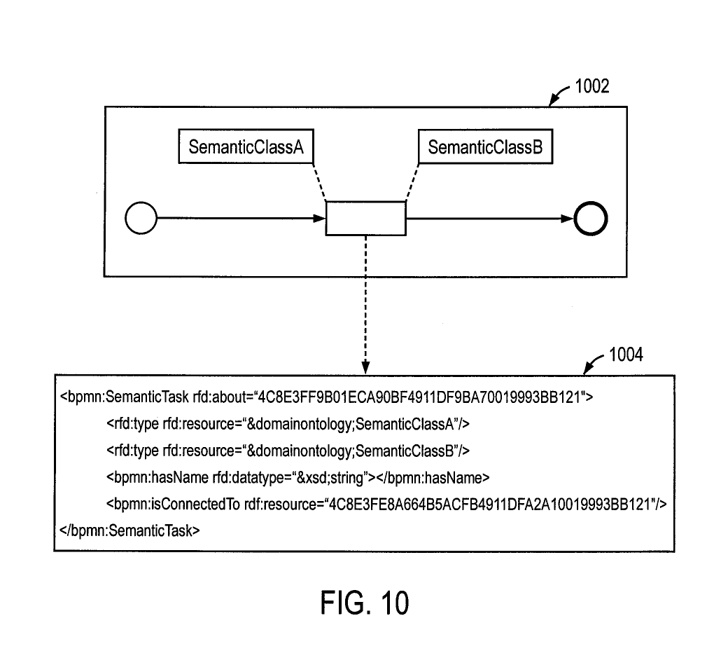

By contrast, FIG. 10 shows an embodiment of a simple BPMN diagram 1002 containing semantically enriched model elements, including a semantic task associated with SemanticClassA and SemanticClassB. FIG. 10 shows how this task, which is associated with two domain concepts, is transformed into a corresponding individual of an OWL ontology. A portion of a corresponding OWL description 1004 (in the RDX/XML format) is also shown, including references for the two semantic classes. In this case, the task within the business process diagram is transformed into an individual of type bpmn:SemanticTask, which is described within the BPMN ontology. Furthermore, the individual is also described as a member of two other OWL classes that are part of a domain ontology and that correspond to the domain concepts with which the task is associated (i.e., SemanticClassA and SemanticClassB). This description 1004 also includes an object property (isConnectedTo: used to evaluate flexible sequence connectors).

In performing semantic enrichment (e.g., as in FIG. 8), tasks, events or gateways within a BPMN model that are associated with specific domain concepts are matched by a generic task, generic event or generic gateway with a corresponding semantic expression, which is an attribute of the respective PPML modeling construct. To check a semantic expression, a reasoner (employed for pattern matching 708 as discussed below) checks if an individual in the business process ontology belongs to the specified OWL classes or their subclasses. Therefore, the BPMN ontology and the respective domain ontologies, which are used to semantically enrich the BPMN model elements, are imported into the business process ontology.

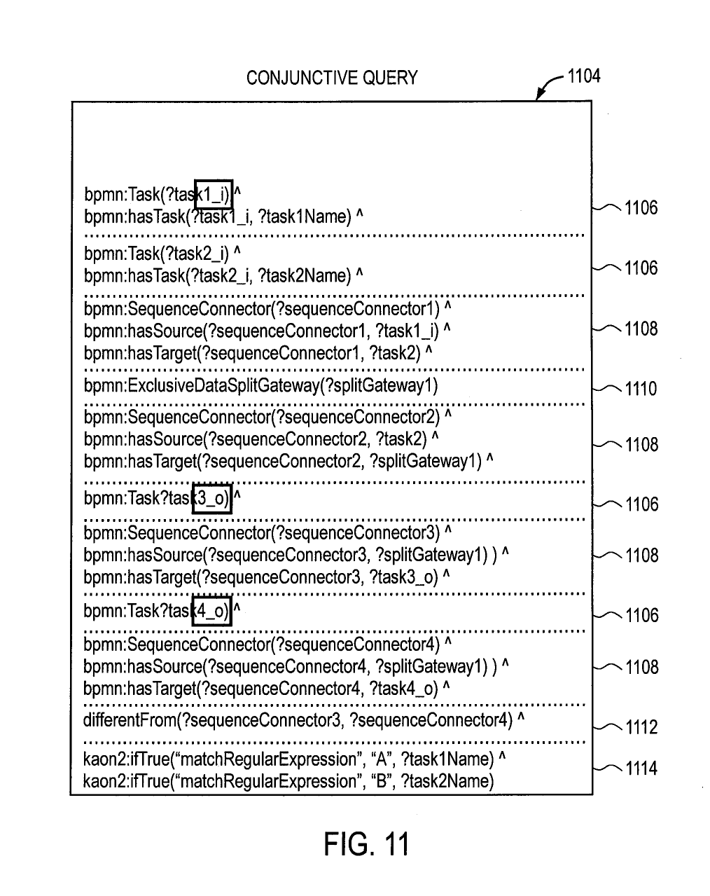

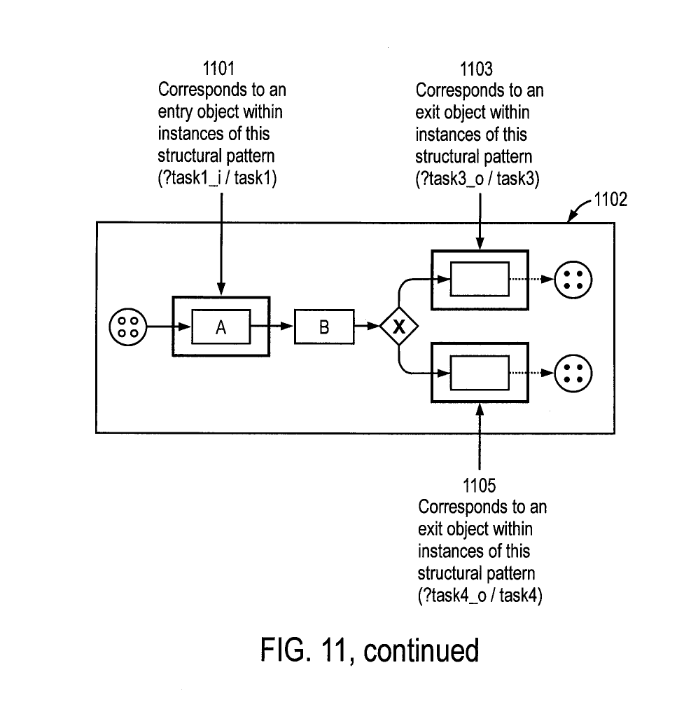

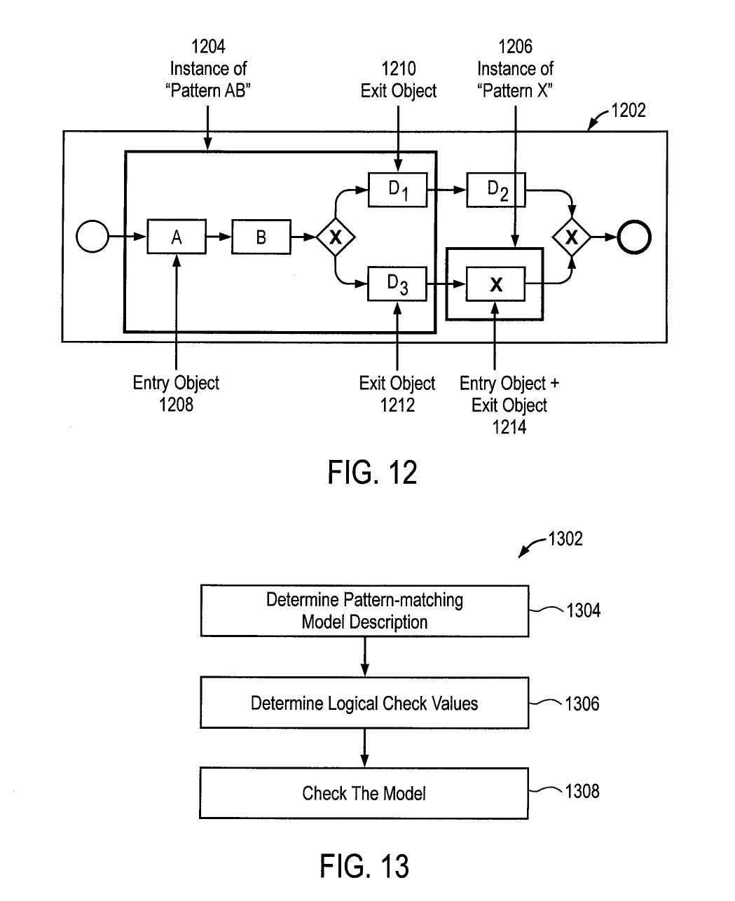

Next, the search query is determined 706 by transforming each structural pattern to the form of a conjunctive query. FIG. 11 shows an example representation 1102 of pattern AB 402 with additional detail shown for model elements that correspond to an entry object 1101 and two exit objects 1103, 1105 within instances of this structural pattern. An entry object of an instance of a structural pattern is a flow object that is not directly connected to a preceding flow object that is also part of the instance. Likewise, an exit object of an instance of a structural pattern is a flow object that is not directly connected to a following flow object that is also part of the instance. FIG. 12, discussed below, highlights two instances of structural patterns 1204, 1206 with entry objects 1208, 1214 and exit objects 1210, 1212, 1214 shown. The determination of entry and exit objects within instances of structural patterns is generally a prerequisite for the evaluation of temporal conditions that are part of pattern-based constraints. A portion of a corresponding conjunctive query 1104 is also shown. Specific functional aspects of the conjunctive query 1104 include finding tasks by name 1106, finding sequence connectors that connect flow objects 1108, finding exclusive data-based gateways 1110, making sure that the sequence connectors following a gateway are disjoint 1112, identifying entry and exit objects (e.g., with “_i” or “_o” for input and output respectively) in correspondence to the notations shown in the pattern representation 1102 and calling a user-defined function (e.g., to match a regular expression) 1114. The incorporation of user-defined functions enables the transformation of certain PPML modeling constructs (FIG. 3) in this process.

The embodiment shown in FIG. 11 desirably enables the identification and analysis of entry and exit objects for structural patterns by using appended suffixes (“_i”, “_o” and “_io”) in the variables. During the transformation of a structural pattern into a conjunctive query, a suffix (“_i”, “_o” or “_io”) is appended to the variables that correspond with entry and exit objects (e.g., as in highlighted portions 1106 related to naming tasks) so that knowledge about entry and exit objects can be used during the evaluation of the pattern-based constraint 212 that references the corresponding structural patterns. Other approaches to pattern matching have generally been limited to operational settings other than business process models as described here. [2, 5, 6]

Next instances of the structural patterns are identified 708 by using a reasoner to process the conjunctive query 1104. [5] FIG. 12 shows a graphical display of the output 1202 including one instance of Pattern AB 1204 and one instance of Pattern X 1206 in correspondence to the patterns 402, 408 shown in FIG. 4. The instance of Pattern AB 1204 includes an entry object 1208 and two exit objects 1210, 1212. The instance of Pattern X 1206 includes a single object 1214 that is both an entry object and an exit object.

A more detailed embodiment for evaluating the constraint 210 is shown in FIG. 13. The method 1302 includes: determining a process-flow description that characterizes the identified instances within the model 1304; determining logical check values that characterize the constraint through logical operations 1306; and checking the model by using the process-flow description to simulate states of the model and using logical check values to verify the constraint on the simulated states 1308.

In a specific version of this embodiment, the process-flow description is determined 1304 as a PROMELA program that can be used as an input to the Spin model checker that will be used for checking the model 1308. Spin offers the C-like language PROMELA to describe state transition systems including processes containing several lines of code, variables with their values and transitions, known as “channels,” that can be used to send tokens from one process to another. [8] To verify a system description, the model checker translates the description into a finite state machine and simulates every reachable state. Two states are different if the lines of code in the PROMELA program are executed in a different order or if variables have different values. Normally all active processes are executed in a parallel manner, but if a process declaration contains a line of code waiting to receive a token through a channel, this process will be blocked at this line until the token arrives.

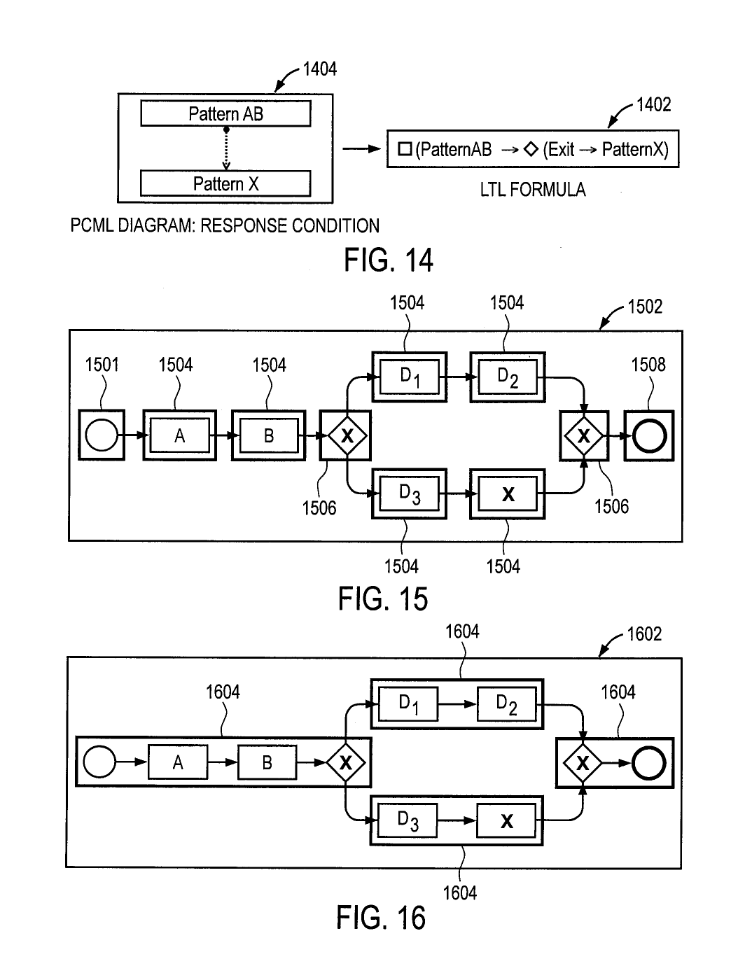

Logical check values are determined 1306 as values for a Linear Temporal Logic (LTL) formula. FIG. 14 shows an example LTL formula that corresponds to the response condition 1404 (e.g., from pattern AB to pattern X). During the verification, all constraints of the system description are verified by evaluating the LTL formula in each state. If the model checker discovers a violation of a constraint during verification, it will typically stop immediately, indicating that the model contains errors. Otherwise, the whole state space will be analyzed in order to prove that each reachable state satisfies the constraints. Therefore it is desirable to keep models (e.g., PROMELA models) as small and simple as possible.

In order to keep the PROMELA models desirably small, the information gained in the pattern matching phase is used to generate an optimized model that contains only the elements relevant to the checked condition. Corresponding temporal conditions only check the sequence of pattern instances (e.g., the sequence of entry and exit object of pattern instances) disregarding other BPMN elements. Therefore, PROMELA models can be generated without translating BPMN elements that are neither entry nor exit objects of a pattern instance except for gateways, which play an important role in this transformation because they turn the process flow into different directions. In PROMELA models, entry and exit objects are represented as code blocks in process declarations setting Boolean variables that are used as references in LTL formulas. For example, in the LTL formula 1402 of FIG. 14 “patternAB”, “patternX” and “exit” are all variables, where “exit” represents the endpoint of the business process model. The influence of a diverging gateway to the process flow is modeled with multiple channels at the end of a process declaration.

FIGS. 15 and 16 illustrate an advantage of decreasing the size (e.g., number of channels) of the PROMELA models. FIG. 15 shows a BPMN diagram 1502 that corresponds to a PROMELA program where each BPMN model element has a corresponding process declaration with a corresponding name for the model 102 of FIG. 1. Process declarations in the corresponding PROMELA program, indicated by additional surrounding boxes in FIG. 15, are generated for a start event 1501, tasks A, B, X, D₁, D₂, and D₃ 1504, two gateways 1506 and an end event 1508.

In FIG. 15, there are process declarations that only receive and send tokens without changing the process flow or the value of a variable (e.g., for tasks D₁, D₂ and D₃). Because they do not contribute to the verification of the process model, they unnecessarily widen the state space of the PROMELA program. FIG. 16 shows an enhanced BPMN diagram 1602 that corresponds to an optimized PROMELA program with fewer process declarations and fewer channels 1604 as indicated by four surrounding boxes compared to ten in FIG. 15. This optimized (i.e., improved) program results from application of the following rules for generating process declarations: (1) create a process declaration for the start event; (2) close a process declaration after a diverging gateway has been reached and create a new process declaration for each outgoing path; (3) close process declarations before a converging gateway is reached; and (4) create a new process declaration for each converging gateway.

As discussed above, the model can be checked 1308 by executing the Spin model checker and evaluating the results. This may include analysis of a Spin output file, a trail file that allows the detailed results to be traced if an error has been found. This file contains the execution order of the PROMELA program which leads to the erroneous state. Spin also allows replaying these trail files to inspect the verification process.

Besides setting Boolean variables to represent entry and exit objects of pattern instances, these locations are tagged in the PROMELA models with function calls that print an ID belonging to the pattern instance to an output stream. Typically these print commands are deactivated during model verification but are available in replay simulations. Therefore Spin's simulation function can be used to trace pattern instances that have been passed during verification. The IDs of the pattern instances and the order of their appearances are obtained during verification, and so a lexical analysis of this output stream can be used to localize the reason for an error and provide logical results for all temporal conditions across states of the system.

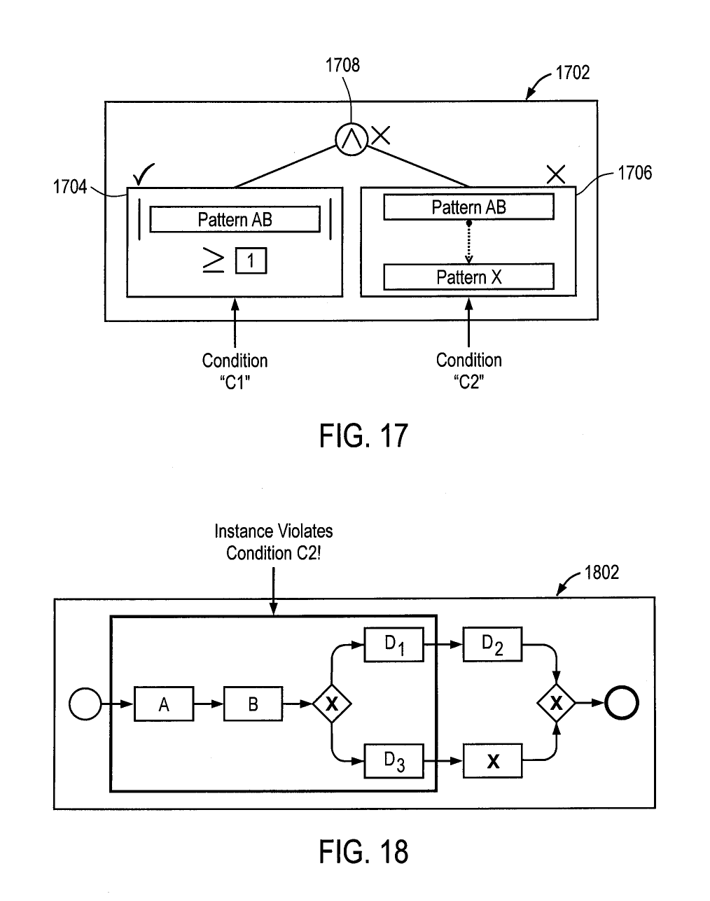

FIG. 17 shows a graphical display 1702 of the evaluated constraint 602 of FIG. 6. In this case condition C1 has been satisfied 1704, but condition C2 has not been satisfied 1706 since not every exit object of an instance of Pattern AB is necessarily followed by an instance of Pattern X. As a result, the overall constraint (logical AND) is not satisfied 1708. FIG. 18 shows a corresponding display 1802 that highlights the violation of condition C2.

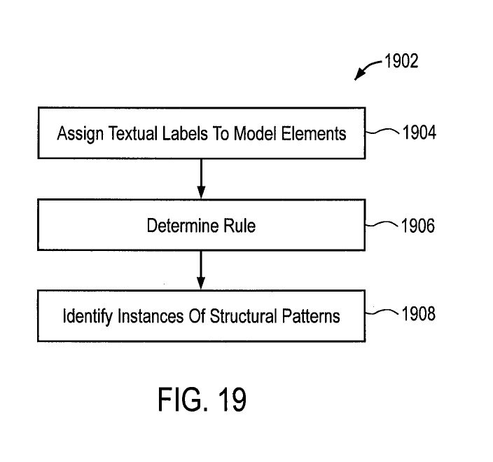

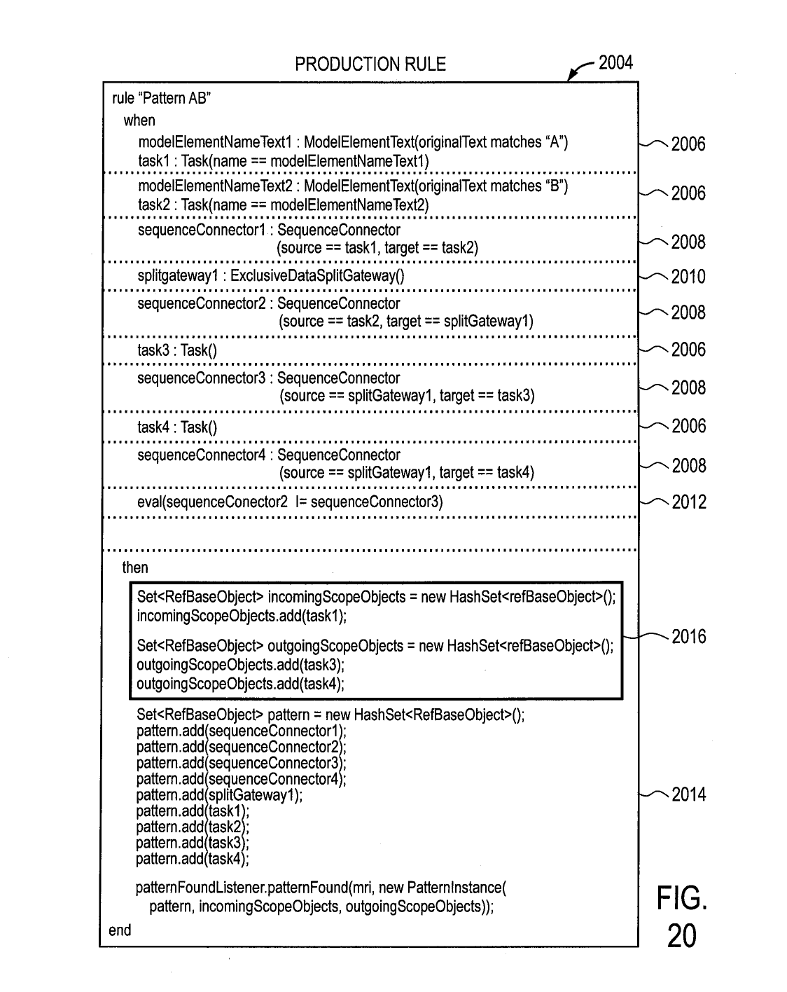

Certain additional embodiments relate to alternatives for identifying instances of structural patterns 210. For example, textual labels can be assigned to model elements as an alternative to assigned classes 204 and a production rule can be evaluated over the assignments to model elements as an alternative to a search query 706. Another more detailed embodiment for specifying the model 204 and identifying instances of the structural patterns 210 is shown in FIG. 19. The method 1902 includes assigning textual labels to the model elements as an aspect of specifying the model 204, where the textual labels correspond to different business concepts for the tasks 1904. Next, as an aspect of identifying instances of the structural patterns 210, a production rule is determined for using the textual labels to identify a structural pattern by logical operations on a combination of textual labels 1906, and instances of the structural patterns are identified by evaluating the rule over elements of the business process model to match the structural pattern 1908.

The assigned textual labels 1904 may be taken from standard BPMN modeling constructs where the meaning of tasks is expressed by labeling them using natural language (e.g., A, B, etc. in FIG. 1). As compared with the embodiments that assign classes to the model elements 704, no semantic enhancement 802 is needed.

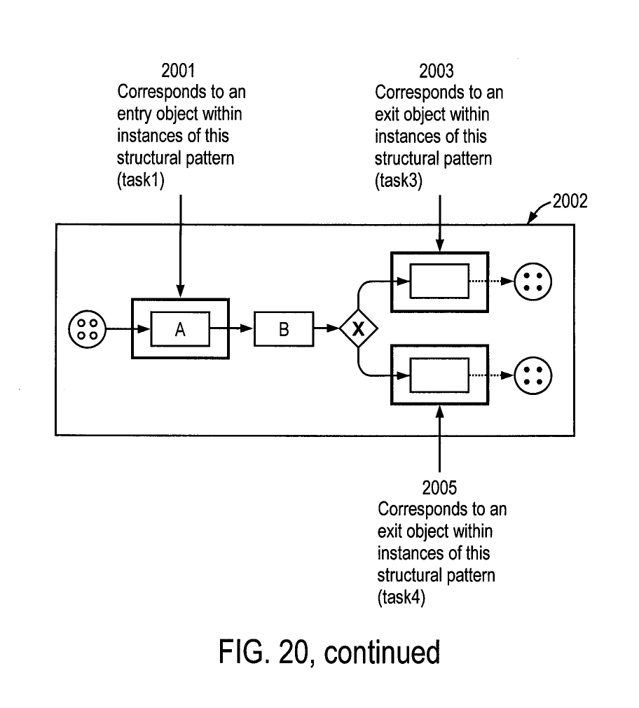

Next, the production rule is determined 1906 by transforming each structural pattern to the form of a rule. FIG. 20, which is analogous to FIG. 11, shows an example representation 2002 of pattern AB 402 with addition detail shown for model elements that correspond to an entry object 2001 of the pattern and two exit objects 2003, 2005 of the pattern. A portion of a corresponding production rule 2004 is also shown. Specific functional aspects of the production rule 2004 include finding tasks by name 2006 (e.g., A, B). Additional functional aspects include finding sequence connectors that connect flow objects 2008, finding exclusive data-based gateways 2010, making sure that the sequence connectors following a gateway are disjoint 2012 and executing a callback function to notify other components that an instance of a structural pattern has been found 2014. This last functionality also includes the identification of entry objects and exit objects for a pattern 2016.

Next instances of the structural patterns are identified 1908 by applying a rules engine to the production rule 2004. Typically the Drools Rules Engine can be used. [9, 10] Similarly as in the embodiment of FIG. 7, FIG. 12 shows a graphical display of the output 1202 including one instance of Pattern AB 1204 and one instance of Pattern X 1206 in correspondence to the patterns 402, 408 shown in FIG. 4.

Additional embodiments include other alternatives for identifying instances of structural patterns 210. These include combining assigned textual labels 1904 with a search query 706 and combining assigned classes 704 with a production rule 2002.At least some values for the results of the above-described methods can be output to a user or saved for subsequent use. For example values for the evaluated constraint 1702, can be saved directly. Alternatively, some derivative or summary form of the results can be saved for later use according to the requirements of the operational setting.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

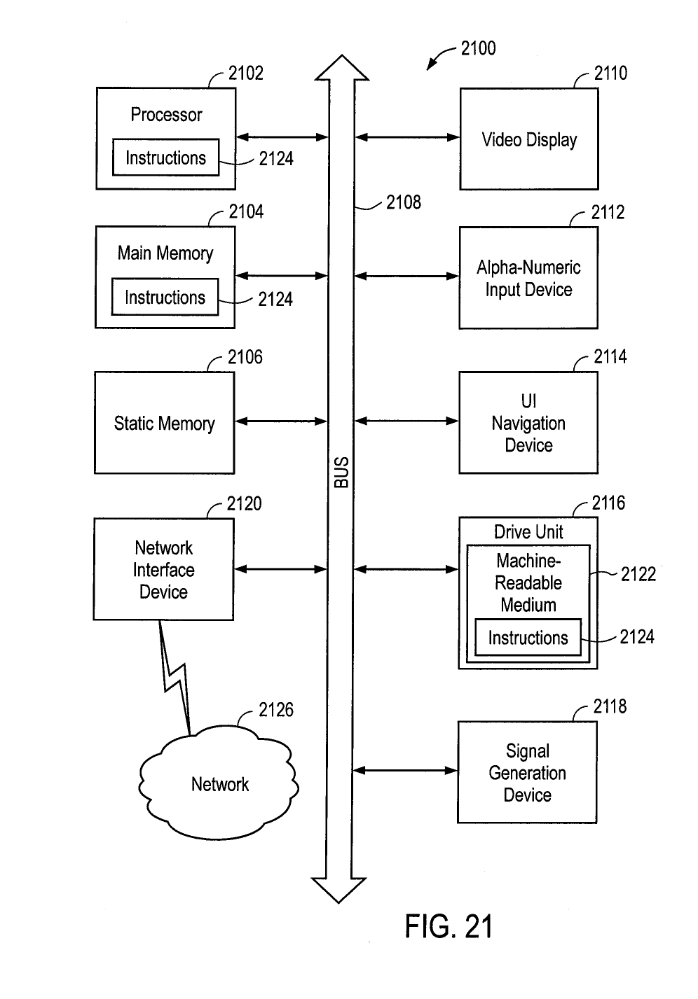

FIG. 21 is a block diagram of machine in the example form of a computer system 2100 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2100 includes a processor 2102 (e.g., a central processing unit (CPU), a graphics processing unit (GPU) or both), a main memory 2104 and a static memory 2106, which communicate with each other via a bus 2108. The computer system 2100 may further include a video display unit 2110 (e.g., a liquid crystal display (LCD) or a cathode ray tube (CRT)). The computer system 2100 also includes an alphanumeric input device 2112 (e.g., a keyboard), a user interface (UI) navigation device 2114 (e.g., a mouse), a disk drive unit 2116, a signal generation device 2118 (e.g., a speaker) and a network interface device 2120.

The disk drive unit 2116 includes a machine-readable medium 2122 on which is stored one or more sets of instructions and data structures (e.g., software) 2124 embodying or utilized by any one or more of the methodologies or functions described herein. The instructions 2124 may also reside, completely or at least partially, within the main memory 2104 and/or within the processor 2102 during execution thereof by the computer system 2100, the main memory 2104 and the processor 2102 also constituting machine-readable media.

While the machine-readable medium 2122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 2124 may further be transmitted or received over a communications network 2126 using a transmission medium. The instructions 2124 may be transmitted using the network interface device 2120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although only certain example embodiments of this invention have been described in detail above, those skilled in the art will readily appreciate that many modifications are possible in the example embodiments without materially departing from the novel teachings and advantages of this invention. For example, aspects of embodiments disclosed above can be combined in other combinations to form additional embodiments. Accordingly, all such modifications are intended to be included within the scope of this invention.

The following references are related to the disclosed subject matter:
[1] Aalst, Willibrordus Martinus Pancratius van der; Pegic, Maja: DecSerFlow: Towards a Truly Declarative Service Flow Language. In: Bravetti, Mario (Hrsg.); Núñez, Manuel (Hrsg.); Zavattaro, Gianluigi (Hrsg.): Web Services and Formal Methods Bd. 4184. Berlin Heidelberg: Springer-Verlag, 2006 (Lecture Notes in Computer Science), S. 1-23.—DOI 10.1007/11841197_{—}1.
[2] Awad, Ahmed: BPMN-Q: A Language to Query Business Processes. In: Reichert,

Manfred (Hrsg.); Strecker, Stefan (Hrsg.); Turowski, Klaus (Hrsg.): Enterprise Modelling and Information Systems Architectures: Concepts and Applications Bd. P-119. Bonn: Gesellschaft fúr Informatik, 2007 (Lecture Notes in Informatics), S. 115-128.
[3] Beeri, Catriel; Eyal, Anat; Kamenkovich, Simon; Milo, Tova: Querying Business Processes with BP-QL. In: Information Systems 33 (2008), Nr. 6, S. 477-507.—DOI 10.1016/j.is.2008.02.005.
[4] Dwyer, Matthew B.; Avrunin, George S.; Corbett, James C.: Property Specification Patterns for Finite-State Verification. In: Proceedings of the Second Workshop on Formal Methods in Software Practice. New York: ACM Press, 1998, S. 7-15.—DOI 10.1145/298595.298598.
[5] di Francescomarino, Chiara: Supporting Documentation and Evolution of Crosscutting Concerns in Business Processes. In: Motahari-Nezhad, Hamid R. (Hrsg.); Toumani, Farouk (Hrsg.); Velegrakis, Yannis (Hrsg.): ICSOC PhD Symposium 2008 Bd. 421, 2008 (CEUR Workshop Proceedings), S. 23-28.
[6] Read, Ronald C.; Corneil, Derek G.: The Graph Isomorphism Disease. In: Journal of Graph Theory 1 (1977), Nr. 4, S. 339-363.—DOI 10.1002/jgt.3190010410
[7] Horridge, Matthew: A Practical Guide To Building OWL Ontologies Using Protege 4 and CO-ODE Tools (Edition 1.2): University of Manchester, 2009.
[8] Vaz, Cátia; Ferreira, Carla: Formal Verification of Workflow Patterns with SPIN/INESC-ID. 2007 (12/2007)—Technical Report
[9] An Introduction to the Drools Project: 2004: downloaded from website theserverside.com.
[10] The Rule Engine: downloaded from website jboss.com.
[11] OMG's MetaObject Facility: downloaded from website omg.org.

What is claimed is:

1. A method of evaluating pattern-based constraints on business process models, comprising:
receiving values for specifying a business process model that includes a first arrangement of model elements including one or more tasks, events or gateways, the tasks corresponding to prescribed activities, the events corresponding to states of the model and the gateways controlling process flow between model elements;
receiving values for specifying one or more structural patterns for the model, wherein each structural pattern includes a corresponding arrangement of one or more model elements including one or more tasks, events or gateways;
receiving values for specifying a constraint on the model by restricting an arrangement in the model of one or more instances of the one or more structural patterns;
using a computer for identifying one or more instances of the one or more structural patterns in the model; and
evaluating the constraint on the model for the one or more identified instances.

2. The method of claim 1, wherein
specifying the model includes assigning classes to the model elements, wherein the classes correspond to different business concepts in a relational data structure of business classifications; and
identifying the one or more instances includes: determining a search query for identifying a first structural pattern as an arrangement of classified model elements, and identifying one or more instances of the first structural pattern by using the search query to search over elements of the business process model to match the first structural pattern.

3. The method of claim 1, wherein
specifying the model includes assigning textual labels to the model elements, wherein the textual labels correspond to different business concepts for the tasks; and
identifying the one or more instances includes: determining a search query for using the textual labels to identify a first structural pattern as an arrangement of textual labels, and identifying one or more instances of the first structural pattern by using the search query to search over elements of the business process model to match the first structural pattern.

4. The method of claim 1, wherein
specifying the model includes assigning textual labels to the model elements, wherein the textual labels correspond to different business concepts for the tasks; and
identifying the one or more instances includes: determining a production rule for using the textual labels to identify a first structural pattern by logical operations on a combination of textual labels, and identifying one or more instances of the first structural pattern by evaluating the production rule over elements of the business process model to match the first structural pattern.

5. The method of claim 1, wherein
specifying the model includes assigning classes to the model elements, wherein the classes correspond to different business concepts in a relational data structure of business classifications; and
identifying the one or more instances includes: determining a production rule for identifying a first structural pattern by logical operations on a combination of classes, and identifying one or more instances of the first structural pattern by evaluating the production rule over elements of the business process model to match the first structural pattern.

6. The method of claim 1, wherein evaluating the constraint on the model includes:
determining a process-flow description that characterizes the one or more identified instances within the model;
determining logical check values that characterize the constraint through logical operations; and
checking the model by using the process-flow description to simulate states of the model and using logical check values to verify the constraint on the simulated states.

7. The method of claim 1, wherein the computer includes a graphical user interface and the method further comprises: receiving values at the graphical user interface that specify a first structural pattern by selecting one or more model elements for the first pattern and one or more connections between the one or more selected model elements.

8. The method of claim 1, wherein the computer includes a graphical user interface and the method further comprises: receiving values at the graphical user interface that specify the constraint by selecting one or more restrictions for arranging one or more instances of the one or more structural patterns.

9. The method of claim 1, wherein the computer includes a graphical user interface and the method further comprises: using the graphical user interface to display a violation of the evaluated constraint.

10. The method of claim 1, wherein the constraint prescribes a presence or an absence of a defined arrangement of the one or more structural patterns.

11. A computer-readable medium that stores a computer program for evaluating pattern-based constraints on business process models, wherein the computer program includes instructions for:
receiving values for specifying a business process model that includes a first arrangement of model elements including one or more tasks, events or gateways, the tasks corresponding to prescribed activities, the events corresponding to states of the model and the gateways controlling process flow between model elements;
receiving values for specifying one or more structural patterns for the model, wherein each structural pattern includes a corresponding arrangement of one or more model elements including one or more tasks, events or gateways;
receiving values for specifying a constraint on the model by restricting an arrangement in the model of one or more instances of the one or more structural patterns;
identifying one or more instances of the one or more structural patterns in the model; and
evaluating the constraint on the model for the one or more identified instances.

12. The computer-readable medium of claim 11, wherein
specifying the model includes assigning classes to the model elements, wherein the classes correspond to different business concepts in a relational data structure of business classifications; and
identifying the one or more instances includes: determining a search query for identifying a first structural pattern as an arrangement of classified model elements, and identifying one or more instances of the first structural pattern by using the search query to search over elements of the business process model to match the first structural pattern.

13. The computer-readable medium of claim 11, wherein
specifying the model includes assigning textual labels to the model elements, wherein the textual labels correspond to different business concepts for the tasks; and
identifying the one or more instances includes: determining a search query for using the textual labels to identify a first structural pattern as an arrangement of textual labels, and identifying one or more instances of the first structural pattern by using the search query to search over elements of the business process model to match the first structural pattern.

14. The computer-readable medium of claim 11, wherein
specifying the model includes assigning textual labels to the model elements, wherein the textual labels correspond to different business concepts for the tasks; and
identifying the one or more instances includes: determining a production rule for using the textual labels to identify a first structural pattern by logical operations on a combination of textual labels, and identifying one or more instances of the first structural pattern by evaluating the production rule over elements of the business process model to match the first structural pattern.

15. The computer-readable medium of claim 11, wherein
specifying the model includes assigning classes to the model elements, wherein the classes correspond to different business concepts in a relational data structure of business classifications; and
identifying the one or more instances includes: determining a production rule for identifying a first structural pattern by logical operations on a combination of classes, and identifying one or more instances of the first structural pattern by evaluating the production rule over elements of the business process model to match the first structural pattern.

16. The computer-readable medium of claim 11, wherein evaluating the constraint on the model includes:
determining a process-flow description that characterizes the one or more identified instances within the model;
determining logical check values that characterize the constraint through logical operations; and
checking the model by using the process-flow description to simulate states of the model and using logical check values to verify the constraint on the simulated states.

17. The computer-readable medium of claim 11, wherein the computer program further includes instructions for providing a graphical user interface that operates to receive user input for specifying a first structural pattern by selecting one or more model elements for the first pattern and one or more connections between the one or more selected model elements.

18. The computer-readable medium of claim 11, wherein the computer program further includes instructions for providing a graphical user interface that operates to receive user input for specifying the constraint by selecting one or more restrictions for arranging one or more instances of the one or more structural patterns.

19. The computer-readable medium of claim 11, wherein the computer program further includes instructions for providing a graphical user interface that displays a violation of the evaluated constraint.

20. The computer-readable medium of claim 11, wherein the constraint prescribes a presence or an absence of a defined arrangement of the one or more structural patterns.

21. An apparatus for evaluating pattern-based constraints on business process models, the apparatus comprising a computer for executing computer instructions, wherein the computer includes computer instructions for:
receiving values for specifying a business process model that includes a first arrangement of model elements including one or more tasks, events or gateways, the tasks corresponding to prescribed activities, the events corresponding to states of the model and the gateways controlling process flow between model elements;
receiving values for specifying one or more structural patterns for the model, wherein each structural pattern includes a corresponding arrangement of one or more model elements including one or more tasks, events or gateways;
receiving values for specifying a constraint on the model by restricting an arrangement in the model of one or more instances of the one or more structural patterns;
identifying one or more instances of the one or more structural patterns in the model; and
evaluating the constraint on the model for the one or more identified instances.
